(19) United States
(12) Patent Application Publication
(10) Pub. No.: US 2012/0328112 A1
(43) Pub. Date: Dec. 27, 2012

(54) REVERBERATION REDUCTION FOR SIGNALS IN A BINAURAL HEARING APPARATUS

(75) Inventors: Marco Jeub, Aachen (DE); Heinrich Loellmann, Aachen (DE); Peter Vary, Aachen (DE)

(73) Assignee: SIEMENS MEDICAL INSTRUMENTS PTE. LTD., SINGAPORE (SG)

(21) Appl. No.: 13/583,393

(22) PCT Filed: Jul. 27, 2010
(86) PCT No.: PCT/EP2010/060849

§ 371 Date: Sep. 7, 2012

(30) Foreign Application Priority Data
Mar. 10, 2010 (EP) 10156082.9

(51) Int. Cl. H04B 3/20; H04R 5/00; H04R 25/00

(52) U.S. Cl. 381/23.1

(57) ABSTRACT

A more efficient method reduces reverberation in binaural hearing systems. This has been done by developing a method for obtaining a reduced-reverberation, binaural output signal, for a binaural hearing apparatus. First of all, a left input signal and a right input signal are provided. The two input signals are combined to form a reference signal. The reference signal is used to ascertain spectral weights, or these weights are provided in another way, in order to use them to reduce late reverberation. To this end, the two input signals have the spectral weight applied to them. Furthermore, a coherency for signal components of the weighted input signals is ascertained. Non-coherent signal components of both weighted input signals are then attenuated in order to reduce early reverberation.

The present invention relates to a method for the provision of a reduced-reverberation binaural output signal in a binaural hearing apparatus. The present invention also relates to a corresponding binaural hearing apparatus. Here, a hearing apparatus should be understood to mean any sound-emitting equipment that can be worn in or on the ear, in particular a hearing aid, a headset, earphones and the like.

Hearing aids are portable hearing apparatuses used to support the hard of hearing. In order to meet the numerous individual needs, different types hearing aids are provided, such as behind-the-ear hearing aids (BTE), hearing aids with an external receiver (RIC: receiver in the canal) and in-the-ear hearing aids (ITE), for example including concha hearing aids or canal hearing aids (ITE, CIC). The hearing aids listed by way of example are worn on the outer ear or in the auditory canal. However, bone conduction hearing aids, implantable or vibrotactile hearing aids are also commercially available. In this case, the damaged sense of hearing is stimulated either mechanically or electrically.

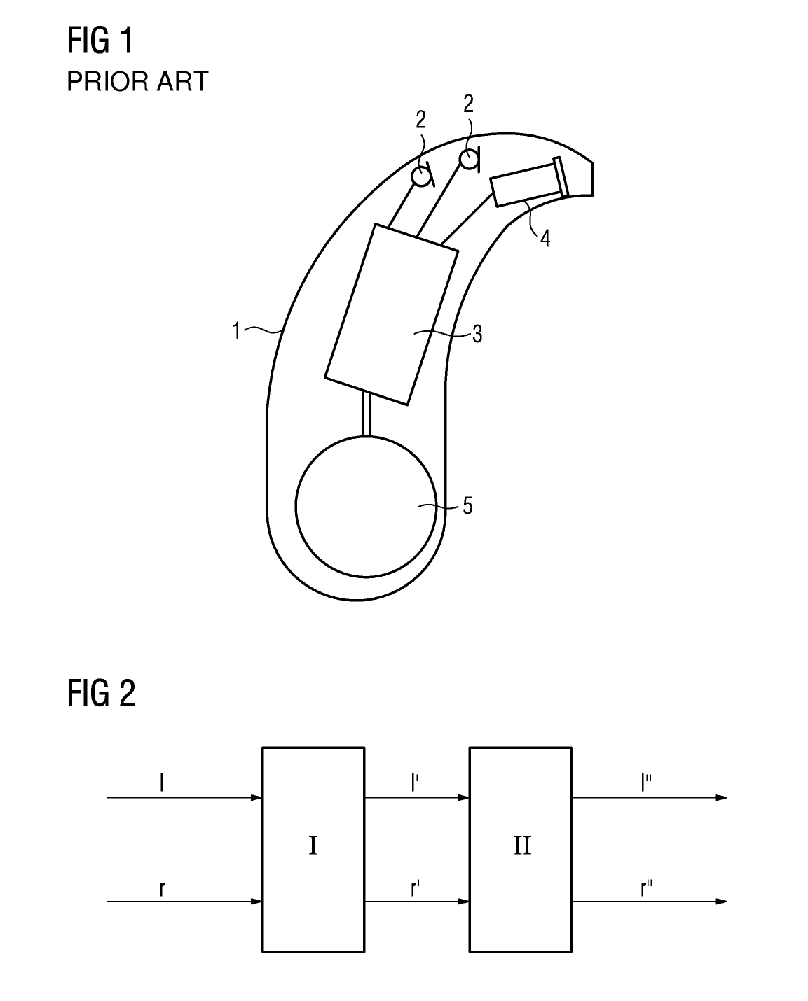

In principle, the main components of hearing aids are an input transducer, an amplifier and an output transducer. The input transducer is generally a sound receiver, for example a microphone, and/or an electromagnetic receiver, for example an induction coil. The output transducer is usually configured as an electroacoustic transducer, for example a miniature loudspeaker, or as an electromechanical transducer, for example a bone conduction receiver. The amplifier is usually integrated in a signal processing unit. The basic design is shown in FIG. 1 using the example of a behind-the-ear hearing aid. One or more microphones 2 for recording the sound from the environment are installed in a hearing-aid housing 1 to be worn behind the ear. A signal processing unit 3, likewise integrated in the hearing-aid housing 1, processes and amplifies the microphone signals. The output signal from the signal processing unit 3 is transferred to a loudspeaker or receiver 4, which emits an acoustic signal. The sound is optionally transferred to the eardrum of the person wearing the apparatus by means of a sound tube, which is fixed in the auditory canal by means of an ear mold. The energy supply for the hearing aid and in particular for the signal processing unit 3 is provided by a battery 5 which is also integrated in the hearing-aid housing 1.

In speech communication systems, room reverberation often leads to a degradation of speech quality and intelligibility. This applies in particular to binaural hearing systems such as, for example, binaural hearing aid systems. The effects of room reverberation can be divided into two different perceptual components: overlap-masking and coloration. Late reverberation, which reaches the receiver via a plurality of reflections, mainly causes masking effects. Early reverberation, on the other hand, causes coloration of the anechoic speech signal.

Many developments have been made in the past to reduce the effects of reverberation and increase the intelligibility of speech. For example, the joint suppression of early and late reverberation in a single-channel using a two-stage approach was suggested. “M. Wu and D. Wang, “A two-stage algorithm for one-microphone reverberant speech enhancement,” IEEE Transactions on Audio, Speech, and Language Processing, Vol. 14, No 3, pages 774-784, 2006” and “N. Gaubitch, E. Habets, and P. Naylor, “Multimicrophone speech dereverberation using spatiotemporal and spectral processing,” in Proc. IEEE International Symposium on Circuits and system (ISCAS), 2008, pages 3222-3225” describe the reduction of early reflections on the basis of the modification of a residual signal obtained by linear prediction, followed by spectral subtraction in order to reduce long-term reverberation. Both methods are unsuitable for binaural-input binaural output processing and would interfere with the binaural auditory impression (interaural level difference and interaural time difference) of a binaural system. The reduction of late reverberation described by Gaubitch et al. is based on “Lebart, K.: “Speech Dereverberation applied to Automatic Speech Recognition and Hearing Aids”, Ph.D. dissertation, L'universite de Rennes, France, 1999”. The calculation of the spectral weights by Lebart contains an estimation of the reverberation time. Also known are earlier algorithms, for example from “R. Ratnam, D. L. Jones, B. C. Wheeler, W. D. O'Brien, C. R. Lansing, and S. S. Feng, “Blind Estimation of the Reverberation Time”, Journal of Acoustical Society of America, 114(5), November 2003, pages 2877-2892” or “R. Ratnam, D. L. Jones, W. D. O'Brien, “Fast Algorithm for Blind Estimation of Reverberation Time, IEEE signal Processing Letters, Vol. 11, No 6, June 2004” or “H. Löllmann, P. Vary, “Estimation of the Reverberation Time in Noisy Environments”, International Workshop on Acoustic Echo and Noise Control, Seattle, USA, September 2008” which perform a quasi-continuous estimation of the reverberation time based on a maximum-likelihood estimator (ML), but this requires high computational complexity.

Also known from “J. Peissing, “Binaural hearing aid strategies in complex noise environments,” Ph.D. dissertation, University of Göttingen, Göttingen, Germany, 1992” is a coherency-based structure for the suppression of noise interference. Furthermore, “L. Danilenko, “Binaural hearing in non-stationary diffuse sound field,” Dissertation, RWTH Aachen University, 1968” and “J. Allen, D. Berkley, and J. Blauert, “Multimicrophone signal-processing technique to remove room reverberation from speech signals,” J. Acoust. Soc. Am., Vol. 62, No 4, pages 912-915, 1977” describe a calculation of spectral coefficients. “M. Jeub and P. Vary, “Binaural dereverberation based on a dual-channel Wiener filter with optimized noise field coherency,” in Proc. IEEE Int. Conference on Acoustics, Speech and signal Processing (ICASSP), Dallas, X, USA, 2010, pages 4710-4713” also describes an improved coherency-based algorithm. Finally

“M. Dörbecker, “Multi-channel signal processing in order to improve acoustically distorted speech signals using the example of electronic hearing aids,” Dissertation, RWTH Aachen University, 1998” discloses a coherency model.

The object of the present invention consists in reducing reverberation in a binaural hearing system in a more effective way.

This object is achieved according to the invention by a method for the provision of a reduced-reverberation, binaural output signal in a binaural hearing apparatus by recording a left input signal and a right input signal by the hearing apparatus, combining the two input signals to form a reference signal, the ascertainment of spectral weights from the reference signal or provision of spectral weights with which late reverberation can be reduced, the application of the spectral weights to the left and right input signal, the ascertainment of a coherency for signal components of the weighted input signals and the attenuation of noncoherent signal components of both weighted input signals in order to reduce early reverberation.

In addition, the invention provides a binaural hearing apparatus with a recording device for recording a left input signal and a right input signal, a signal processing device for combining the two input signals to form a reference signal, a weighting device for the ascertainment of spectral weights from the reference signal or the provision of spectral weights with which late reverberation can be reduced and for the application of the spectral weights to the left and right input signal and a coherency device for the ascertainment of a coherency for signal components of the weighted input signals and for the attenuation of noncoherent signal components of both weighted input signals in order to reduce early reverberation.

Therefore, in an advantageous way, according to the invention, a binaural dereverberation algorithm is used with which reverberation is reduced with spectral weights obtained from a combined signal (right signal with left signal) in the frequency range. Early reverberation is also reduced by taking into account the coherency between the left and right signal. This ensures high-quality dereverberation.

The reduction of the late reverberation utilizes a reference signal, which is obtained by combining the left and right signal in the binaural hearing apparatus. During the combination, preferably a time difference between the two input signals is compensated and the two input signals are added together to form the reference signal. This enables a single reference signal to be obtained with which weights for the reduction of late reverberation can be obtained for both individual input signals.

When the spectral weights from the reference signal are determined, it is advantageous to estimate the reverberation time from the reference signal to this end. To estimate the reverberation time, it is particularly advantageous to preselect segments of the reference signal. This, on the one hand, enables the reverberation time to be estimated very reliably and, on the other, the computational effort to be significantly reduced.

Preferably, the preselection will only involve the selection of those segments within which a fall in the sound level is detected. This fall can be used to estimate the reverberation time.

To estimate the reverberation time, one fall time is determined for each of the preselected segments and the fall time that occurs with the greatest probability is defined as the reverberation time. This achieves a more robust method for obtaining the reverberation time.

Furthermore, when estimating the reverberation time, the length of each of the segments is matched to the length of its fall in sound. The variable length of the segments enables a significant saving of computational effort.

It is furthermore advantageous, if, for the ascertainment of the spectral weights for the reduction of the late reverberation, the energy of this late reverberation is estimated. The energy estimation does not necessarily require an estimation of the reverberation time, instead the energy can also be determined solely from the correlation of the spectral coefficients. Only with knowledge of the energy of the interference noise (reverberation) can said noise be effectively reduced.

Here, a coherency method is used to reduce early reverberation in the binaural system. During the ascertainment of the coherency, advantageously a coherency model is used which takes into account the shading effects of a user's head. This models natural hearing conditions in which the individual devices of the binaural hearing system are worn on the left and right ear and the head is located therebetween as an acoustic disruption.

The attenuation of noncoherent signal components for the reduction of early reverberation is preferably performed after the weighting or filtering of the input signals for the reduction of late reverberation. However, it is in principle also possible to perform these two processing steps in reverse order. In some circumstances, the reversal reduces the efficacy of the entire method.

The present invention will now be explained in more detail with reference to the attached drawings, which show:

FIG. 1 the basic design of a hearing aid according to the prior art;

FIG. 2 a block diagram of a two-stage deverberation system and

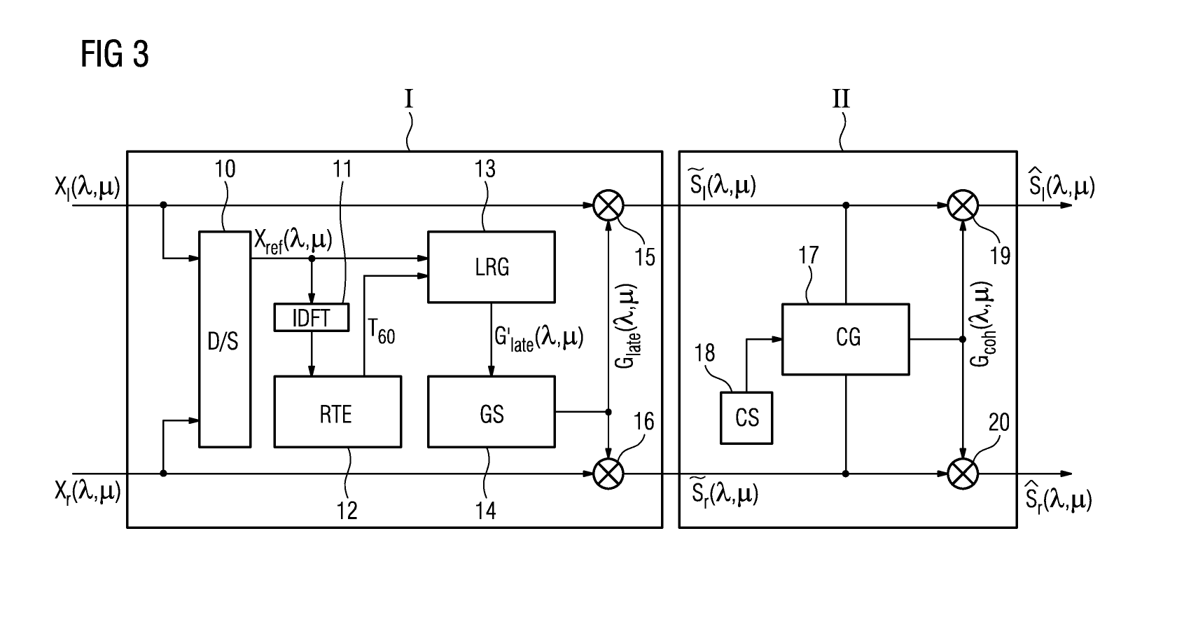

FIG. 3 a detailed block diagram of a two-stage deverberation system.

The exemplary embodiments described in more detail below represent preferred embodiments of the present invention.

One embodiment of the invention uses a binaural, two-stage algorithm enabling combined reduction of early and late reverberation and in principle safeguarding the binaural auditory impression. An algorithm of this kind is described in M. Jeub, M. Schäfer, T. Esch and P. Vary: “Model-based dereverberation preserving binaural cues”, Preprint 2010, IEEE Transactions on Audio, Speech and Language Processing. A special application of the coherency method is developed in the above-mentioned article “M. Jeub and P. Vary, “Binaural dereverberation based on a dual-channel wiener filter with optimized noise field coherency,” in Proc. IEEE Int. Conference on Acoustics, Speech and signal Processing (ICASSP), Dallas, Tex., USA, 2010”, pages 4710-4713. Explicit reference is made to both articles here.

FIG. 2 shows a simplified block diagram of an exemplary two-stage deverberation system. The deverberation system is implemented, for example, in a hearing aid system with two hearing aids (one for the left ear and one for the right ear). The two hearing aids of the hearing aid system have a communication link with each other. For example, the microphone signal of the right hearing aid is transferred to the left hearing aid and the deverberation system is integrated in the left hearing aid. Then, both input signals 1 and r (left channel and right channel) are available to the binaural deverberation system as shown in FIG. 2. In a first processing stage I, a corresponding algorithm ensures the reduction of late reverberation. The output of the first stage I is a binaural signal with a left intermediate signal 1′ and a right intermediate signal r′ corresponding to the left channel and the right channel. In the two intermediate signals 1′ and r′, the late reverberation that was still present in the input signals 1 and r, is reduced.

The two intermediate signals 1′ and r′ are supplied to a second processing stage II. This implements a coherency-based algorithm which improves the two signals with respect to early reverberation. This means early reverberation is reduced in the left intermediate signal 1′ resulting in an improved left output signal 1″. Early reverberation is also reduced in the right intermediate signal r′ resulting in an improved right output signal r″. Therefore, at the end of the deverberation system, an improved binaural signal with a right channel and a left channel is available with which both the late reverberation and also the early reverberation is reduced.

FIG. 3 is a block diagram providing a detailed description of the two processing stages I and II in FIG. 2. Here, the input signals X₁ (λ, μ) and Xᵣ (λ, μ) in the first processing stage I, which correspond to the input signals 1 and r in FIG. 2, are in the frequency range. This means that before the processing in the deverberation system shown, transformation into the frequency range takes place. The index λ designates a segment or a frame of the respective input signal. The input signal is namely segmented and in transformed into short time spectra. The index μ designates a frequency range.

Within the first processing stage I, the two input signals of the left and right channel are supplied to a combination unit 10, in which the left input signal X₁ (λ, μ) and the right input signal Xᵣ (λ, μ) are combined to form a reference signal X_{ref} (λ, μ). The two input signals are here combined in such a way that the temporal difference between the two signals is compensated and they are then added together. The reference signal X_{ref} (λ, μ) is back-transformed into the time range by a back-transformation unit 11. An estimation device 12 calculates the reverberation time from the reference signal in the time range. The reverberation time is defined as the time interval in which the energy of a stationary sound field falls 60 dB below the initial level after the sound source has been switched off. The estimation of the reverberation time can for example be performed blind, this means the reverberation time is obtained from a reverberation signal without knowledge of the excitation signal or the room geometry.

A further-developed form of the reverberation time estimation device 12 uses an improved algorithm for the blind reverberation time estimation. This improved algorithm preferably consists in the fact that a noisy and reverberant speech signal is initially processed by an interference noise suppression system in order to obtain an interference-suppressed, reverberant speech signal. After this, the actual reverberation time estimation is performed. The main steps of this algorithm are as follows: in a first step, sub-sampling is performed to permit a reduction in the computational complexity of the algorithm. With moderate sub-sampling, it is still possible to determine a fall in energy adequately.

In a second step, preselection is performed in order to detect segments in which fall in sound (fall in the energy of the sound). This detection takes place in the following substeps:

1. The input signal, which has already been divided into frames or segments, is divided into sub-frames and a counter is initialized to zero.

2. The energy, the maximum value and the minimum value of a sub-frame is compared with the values of the next sub-frame.

3. If the energy, the maximum value and the minimum value of the next sub-frame are smaller than the values for the current sub-frame, the counter is increased by one. Otherwise, the counter is set to zero.

4. If the energy, the maximum value and the minimum value of the next sub-frame are greater than the values for the current sub-frame, a check is performed to determine whether the counter has already reached a minimum value. The minimum value is, for example, three; if there are at least three values, it can namely be assumed that this is not a random fall in energy within two sub-frames but instead an actually desired fall in energy. Therefore, if the counter has achieved a preset minimum value, it is assumed there is a fall in sound. This is also the case if the counter reaches a preset maximum value. A maximum value is preset since, when it reaches the maximum value, the number of sub-frames is then sufficient for an estimation. In both cases (the counter reaches the minimum value or the maximum value), the counter is set to zero and the reverberation time is calculated with the aid of an ML estimator as, for example, described in [Ratnam et al., 2003]. The estimation is performed for a group of the last successive sub-frames with which the counter is incremented. Therefore, the length of a group of this kind, with which the ML estimation was applied, is not fixed but matched to the (detected) fall in voice. This ML estimation represents a third step of the reverberation time estimation.

The value for the reverberation time obtained by the ML estimation is used in order, in a fourth step, to update a histogram comprising the ML estimated values, which were calculated within a preset, past time interval.

In a fifth step, a value for the reverberation time represented by the maximum in the histogram is used in order to select or define the actual reverberation time. Finally, in a sixth step, the values of the estimated reverberation time are smoothed over time in order to reduce the variance of the estimation.

The advantage of preselection consists in the fact that a significant reduction in the computational complexity can be achieved. Unlike the case with the earlier algorithms [Ratnam 2003, Ratnam 2004, Löllmann 2008], the new approach uses an adaptive buffer length for the ML estimation, which increases the accuracy of the estimation, in particular for low reverberation times. In addition, the actual reverberation time is determined by the maximum of the histogram and not by its first peak.

To return to FIG. 3, therefore a reverberation time T₆₀ is determined in the estimator unit 12. This value T₆₀ is supplied together with the reference signal in the frequency range to a calculation unit 13, which uses it to determine in a known way, for example via an energy estimation, weights G′ₗₐₜₑ (λ, μ) for the reduction of late reverberation. These determined weights are temporally smoothed over several segments or frames of the input signal in a smoothing unit 14. This finally results in the weights Gₗₐₜₑ (λ, μ). In a last step of the first processing stage I, the smoothed weights Gₗₐₜₑ (λ, μ) are multiplied with both the left input signal X₁ (λ, μ) and the right input signal Xᵣ (λ, μ) in the multiplication units 15 and 16. The products obtained are, for the left channel, the signal \check{S}₁ (λ, μ) and, for the right channel, the signal \check{S}ᵣ (λ, μ), which correspond to the intermediate signals 1′ and r′ in FIG. 2. Hence, in the first processing stage I, a binaural spectral subtraction is performed for the reduction of late reverberation.

The signals \check{S}₁ (λ, μ) and \check{S}ᵣ (λ, μ) resulting from the first processing stage I are now, in a second processing stage II, free of early reverberation to the greatest degree possible. This is achieved in that a binaural coherence Wiener filter is used. In the present example, the filter has a computing unit 17 in order to obtain corresponding weights G_{coh} (λ, μ) for the attenuation of noncoherent signal components from a coherency of the signals of the left channel and right channel. The computing unit 17 uses a coherency model 18 for this. This integrated coherency model 18 takes into account shading effects from a user's head with respect to the coherency of the interference noise field. For example, a coherency model is used such as that suggested in the article “Binaural dereverberation based on a dual-channel Wiener filter with optimized noise field coherency” by M. Jeub and P. Vary. The improved model relates to the coherency of the interference noise field instead of an ideal, diffuse interference noise field without head shading. The coherency model 18 can be based on that of [Dörbecker 1998].

The weights G_{coh} (λ, μ) obtained by the computing unit 17 are multiplied with the signal \check{S}ᵣ (λ, μ) in order to obtain a reduced-reverberation output signal \check{S}(λ, μ) in the left channel and with the signal \check{S}ᵣ (λ, μ) of the right channel in order to obtain a reduced-reverberation signal \check{S}ᵣ (λ, μ) in the right channel. The multiplication units 19 and 20 are provided to this end.

The main advantage of the combination shown in FIGS. 2 and 3 consists in the fact that, in the processing stage I, primarily late reverberation components are reduced, while, in processing stage II, the subsequent Wiener filter attenuates all noncoherent signal components. This results in an effective reduction of both early and late reverberation components. The two-channel system structure means the binaural auditory impression is not influenced.

In an alternative embodiment, the second processing stage II can take place before the first processing stage I. However, in this case, in certain circumstances, there may be a slight decrease in the efficacy of the reverberation reduction. In addition, the processing stages I and II, which are independent of each other, can also be interwoven. Then, the two stages cannot be recognized automatically.

As already indicated above, in a further exemplary embodiment, no reverberation time estimation with a estimator unit 12 is performed. Then, a correlation of the spectral coefficients is used to determine the energy of late reverberation.

In yet another embodiment, the reverberation time is once again not estimated, but fixed in advance. In this case, a compromise is found for different acoustic circumstances. The presetting of the value for the reverberation time enables a significant saving in computational effort with the drawback of less efficient reverberation reduction.

1-11. (canceled)

12. A method for obtaining a reduced-reverberation binaural output signal for a binaural hearing apparatus, which comprises the steps of:
providing a left input signal and a right input signal;
combining the left and right input signals to form a reference signal;
performing one of ascertaining spectral weights from the reference signal or providing the spectral weights with which late reverberation can be reduced;
applying the spectral weights to the left and right input signals resulting in weighted input signals;
ascertaining a coherency for signal components of the weighted input signals; and
attenuating non-coherent signal components of the weighted input signals in order to reduce early reverberation.

13. The method according to claim 12, wherein during the combining step, compensating for a time difference between the left and right input signals and adding the left and right input signals to the reference signal.

14. The method according to claim 12, which further comprises:
determining the spectral weights from the reference signal; and
estimating a reverberation time from the reference signal.

15. The method according to claim 14, wherein for estimating the reverberation time, making a preselection from segments of the reference signal.

16. The method according to claim 15, wherein, during the preselection, selecting the segments within which a fall in a sound level is detected.

17. The method according to claim 16, which further comprises ascertaining a fall time for each of the segments preselected and the fall time that occurs with a greatest probability is defined as the reverberation time.

18. The method according to claim 15, which further comprises matching a length of each of the segments to a respective length of a fall in sound.

19. The method according to claim 12, which further comprises estimating energy of the late reverberation for ascertainment of the spectral weights.

20. The method according to claim 12, which further comprises using a coherency model taking into account shading effects of a user's head for an ascertainment of the coherency.

21. The method according to claim 12, which further comprises performing an attenuation of the non-coherent signal components for a reduction of the early reverberation before a weighting of the left and right input signals for a reduction of the late reverberation.

22. A binaural hearing apparatus, comprising:
a recording device for recording a left input signal and a right input signal;
a signal processing device for combining the left and right input signals to form a reference signal;
a weighting device for ascertaining spectral weights from the reference signal or for providing the spectral weights with which a late reverberation can be reduced for an application of the spectral weights to the left and right input signals; and
a coherency device for ascertaining a coherency for signal components of weighted input signals and for an attenuation of non-coherent signal components of the weighted input signals in order to reduce early reverberation.
